(19) United States
(12) Patent Application Publication
(10) Pub. No.: US 2024/0343416 A1
(43) Pub. Date: Oct. 17, 2024

(54) INTEGRATED AVIONICS UNIT

(71) Applicant: ASTROBOTIC TECHNOLOGY, INC., PITTSBURGH, PA (US)

(72) Inventors: CEDRIC CORPA DE LA FUENTE, PITTSBURGH, PA (US); TROY ARBUCKLE, FARMINGTON, UT (US); KERRY QUINN, PITTSBURGH, PA (US); ANDREA DAVIS, PITTSBURGH, PA (US); MIKE PROVENZANO, HURLEY, NY (US); JOSEPH ZIMO, CHICAGO, IL (US); UPASANA LNU, SEWICKLEY, PA (US); JOSHUA SHAPIRO, CRANBERRY TWP, PA (US); NOAH GASPARRO, IRWIN, PA (US)

(73) Assignee: ASTROBOTIC TECHNOLOGY, INC., PITTSBURGH, PA (US)

(21) Appl. No.: 18/633,447

(22) Filed: Apr. 11, 2024

Related U.S. Application Data
(60) Provisional application No. 63/458,669, filed on Apr. 12, 2023.

(51) Int. Cl. B64G 1/16; B64G 1/40; B64G 1/42; B64G 1/66

(52) U.S. Cl. CPC B64G 1/16; B64G 1/411; B64G 1/425; B64G 1/66

(57) ABSTRACT

A spacecraft includes a body having a motor, a lander interface, a sensor and a power source for powering the motor and the sensor, and the power source being mounted thereon. An integrated avionics unit has a module and an integrated circuit with the module having a central computer and a motor controller for controlling the motor and the integrated circuit having a temperature monitoring system for monitoring the temperature of the spacecraft and a power regulator having a cell balancer for regulating the power of the power source. The module and the integrated circuit are connected to one another for constant communication therebetween. The central computer communicates with the sensor.

### CROSS REFERENCE TO RELATED APPLICATION

This application claims the benefit under 35 U.S.C. § 119 (e) of co-pending U.S. Provisional Application No. 63/458,669 entitled “INTEGRATED AVIONICS UNIT” filed Apr. 12, 2023, which is incorporated herein by reference.

### STATEMENT REGARDING FEDERALLY SPONSORED RESEARCH OR DEVELOPMENT

This invention was developed under Contract No. 80NSSC21C0046 awarded by the National Aeronautics and Space Administration. The Government has certain rights in this invention.

### TECHNICAL FIELD

The subject disclosure is directed to systems, methods, and apparatus for an integrated avionics unit (IAU) for use within a spacecraft.

### BACKGROUND ART

Computing systems utilized in spacecraft have come a long way from core rope memory on the Apollo Guidance computer to millions of transistors on a chip smaller than a fingernail. Classical spacecraft computing systems utilize a central onboard computer connected to various platform subsystems, such as the radio communication, attitude and orbit control, payloads, and other similar subsystems. Such computing systems are suitable for handling routine spacecraft tasks, such as attitude control, housekeeping reports, command decoding, and systems management, which require very little processing power.

However, there is a need for more sophisticated spacecraft computer systems to perform more demanding tasks, such as executing payload software, performing intensive digital signal processing, formatting data, and performing error control, or encryption functions. Such tasks require sophisticated processors and, in some cases, peripheral supporting devices. Unfortunately, these functions have been performed with space-grade technology, which is significantly slower as compared to contemporary terrestrial counterparts.

Spacecraft that employ robotic systems provide additional challenges due to the need for autonomous guidance in unknown environments through the use of active or passive image sensors to perceive the surrounding environment. Vision applications in space vary from rover exploration on Mars with simultaneous localization and mapping to moon landing with landmark tracking and hazard avoidance, and to spacecraft proximity operations with pose estimation of cooperative or uncooperative orbiting targets. The ever-increasing computational demands of such enabling technologies challenge classical onboard computing systems in terms of architecture and processing power.

Moreover, computing systems employed in space can be subject to severe harm by the harsh environmental conditions of high vacuum, extreme temperatures, and high levels of ionizing radiation, or even by the vibrations during launch. Due to the demanding nature of these advance applications and harsh environments, there is a need for an improved avionics system for spacecraft.

### DISCLOSURE OF INVENTION

The following summary is provided to introduce a selection of concepts in a simplified form that are further described below in the detailed description. This summary is not intended to identify key features or essential features of the claimed subject matter, nor is it intended to be used to limit the scope of the claimed subject matter.

In various implementations, an integrated avionics unit for use in spacecraft is provided. A pair of electronic boards consists of a first electronic board and a second electronic board connected to one another for constant communication therebetween with the first electronic board having a central computer and the second electronic board having an integrated circuit. A motor controller controls at least one motor in the spacecraft with the first electronic board directing the operation thereof. A temperature control system for controls the interior temperature of the spacecraft with the temperature control system having one heater controller and one temperature monitor with the second electronic board directing the operation thereof. A power control system regulates the power of the spacecraft with the power control system having a power regulator and a cell balancer with the second electronic board directing the operation thereof.

In other implementations, a spacecraft includes a body having a motor, a sensor and a power source for powering the motor and the sensor with the motor, the sensor, and the power source being mounted thereon. An integrated avionics unit has a module and an integrated circuit with the module having a central computer and a motor controller for controlling the motor and the integrated circuit having a temperature monitoring system for monitoring the temperature of the spacecraft and a power regulator having a cell balancer for regulating the power of the power source. The module and the integrated circuit are connected to one another for constant communication therebetween. The central computer communicates with the sensor.

These and other features and advantages will be apparent from a reading of the following detailed description and a review of the appended drawings. It is to be understood that the foregoing summary, the following detailed description and the appended drawings are explanatory only and are not restrictive of various aspects as claimed.

### BRIEF DESCRIPTION OF THE DRAWINGS

FIG. 1 is a schematic diagram of the architecture for an embodiment of a spacecraft.

FIG. 2 is a schematic diagram of an integrated avionics unit for use within the spacecraft shown in FIG. 1.

FIG. 3 is a schematic diagram of the architecture for another embodiment of a spacecraft.

FIG. 4 is a schematic diagram of an integrated avionics unit for use within the spacecraft shown in FIG. 3.

FIG. 5 is a schematic diagram of the architecture for another embodiment of a spacecraft.

FIG. 6 is a schematic diagram of an integrated avionics unit for use within the spacecraft shown in FIG. 5.

FIG. 7 is an exemplary process in accordance with the disclosure.

FIG. 8 is an exploded perspective view of an exemplary spacecraft in accordance with this disclosure.

FIG. 9 illustrates a block diagram of a computing system operable to execute the disclosed systems and methods in accordance with this disclosure.

### MODES FOR CARRYING OUT THE INVENTION

The subject disclosure is directed to an IAU suitable for use with planetary rovers, excavators, landers, satellites, and any other spacecraft or application related to spacecraft. The IAU can be utilized in applications that require autonomy and multiple motor controllers. The IAU is very low size, weight, and power (SWaP) and is designed to operate and survive at lunar day temperatures.

The IAU includes a processor board attached to a carrier board. The processor acts as the central brain, while the carrier board houses other ancillary components such as a radio, a coprocessor microcontroller, and motor controllers.

The detailed description provided below in connection with the appended drawings is intended as a description of examples and is not intended to represent the only forms in which the present examples can be constructed or utilized. The description sets forth functions of the examples and sequences of steps for constructing and operating the examples. However, the same or equivalent functions and sequences can be accomplished by different examples.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

Numerous specific details are set forth in order to provide a thorough understanding of one or more embodiments of the described subject matter. It is to be appreciated, however, that such embodiments can be practiced without these specific details.

Various features of the subject disclosure are now described in more detail with reference to the drawings, wherein like numerals generally refer to like or corresponding elements throughout. The drawings and detailed description are not intended to limit the claimed subject matter to the particular form described. Rather, the intention is to cover all modifications, equivalents and alternatives falling within the spirit and scope of the claimed subject matter.

The subject disclosures is directed to spacecraft that include a novel IAU. In one exemplary embodiment, the IAU includes a carrier board, a main-processor subsystem, a power management and/or battery management subsystem, a power conditioning system, a watchdog subsystem, a radio subsystem, and a mobility subsystem. Optionally, the IAU includes a solar power management system. The spacecraft is a rover.

The carrier board includes a printed circuit board assembly (PCBA) that connects all subsystems, as well as interfaces. The main processor subsystem include a PCBA that includes a main Computing Processor Unit (CPU), memory to store volatile data, mass storage to store application and recorded mission data, and a power management system that monitors the power on each rail. The main processor subsystem board is connected to the carrier board via board-to-board connectors.

The power management subsystem includes an integrated circuit in the carrier board that manages the balancing, charging, and discharging of the rover battery. The power management subsystem monitors and logs battery usage and manages the power output from a solar panel (when present). The battery subsystem manages the selection of the power source between the solar panel and a lander.

The watchdog subsystem includes an integrated circuit in the carrier board that manages the system heartbeat and telemetry data collected throughout the system (voltages, currents, temperatures). The watchdog subsystem can manage temperature for a rover during all phases of a mission.

The mobility subsystem includes a sub-assembly that includes circuitry in a carrier board and motor drivers that are connected to the carrier board that manage the driving and monitoring of motors.

In another exemplary embodiment, an IAU includes two electronic boards, a system on module (SOM or processor board) and carrier board. The boards are modular and can be stacked to support more complex spacecraft applications.

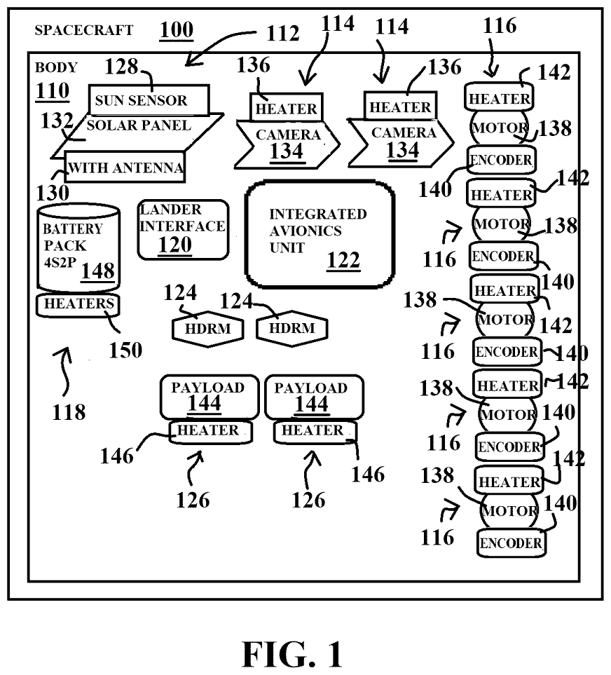

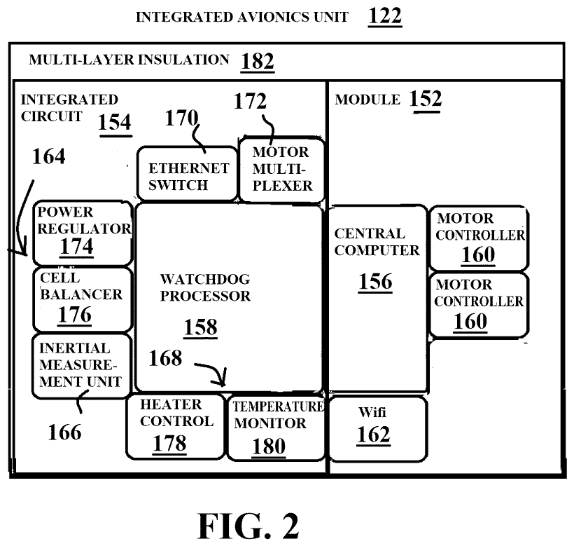

Referring now to the drawings and, in particular, to FIGS. 1-2, there is shown a spacecraft, generally designated by the numeral 100, having a body 110. The body 110 includes a solar array assembly 112, a pair of sensor assemblies 114, a plurality of motor assemblies 116, a power source 118, a lander interface 120, an IAU 122, a pair of hold down release mechanisms (HDRM) 124, and a pair of payload assemblies 126. In this exemplary embodiment, the spacecraft 100 is a rover.

The solar array assembly 112 includes a sun sensor 128, an antenna 130, and a solar panel 132. Each sensor assembly 114 includes a camera 134 and a heater 136. Each motor assembly 116 includes a motor 138, an encoder 140, and a heater 142. Each payload assembly 126 includes a payload 144 and a heater 146. The power source 118 is a battery pack 148 with a heater 150.

As indicated in FIG. 2, the IAU 122 includes a pair of electronics boards 152-154. The electronic board 152 comprises a module that includes a system on module or central computer 156. The electronic board 154 comprises a carrier board that includes a watchdog processor or an integrated circuit 158.

The central computer 156 connects to the integrated circuit 158 for constant communication therebetween. The central computer 156 and the integrated circuit 158 are in constant communication, this way any faults can be relayed back to mission control as well as to inform the central computer 156 of any subsystem downtime due to a fault or to intelligently limit functionality if temperatures or power draws on subsystems are different than anticipated.

The electronic boards 152-154 are modular and can be stacked to support more complex spacecraft applications. The optimum break of functionalities between different boards minimizes the weight of the avionics, while maintaining expandability, modularity, and reusability.

The central computer 156 can include an interface that is identical in all IAUs (not shown). Through the use of a common interface, subsystems can be developed in parallel. Further, the development of new IUAs (not shown) can be expedited since the interface is known.

The central computer 156 performs the main processing for the spacecraft 100. The central computer 156 can include a Quad-core 1.5 GHz processor, 4 GB of application storage, and 2 GB of DDR4 SDRAM. In this exemplary embodiment, the central computer 156 can utilize the Linux Operating System, high speed data busses such as PCIe, USB 3.0, GigE, low speed data busses such as UART, CAN, SPI, and a general purpose Input/Output system. The central computer 156 can directly connect to a wide array of sensors, and actuators to suit the needs of any mobile application.

The integrated circuit 158 can function as a co-processor or watchdog processor. The integrated circuit 158 comprises a small, low-power co-processor that performs functions that require small amounts of control logic, as well as system monitoring functions. The integrated circuit 158 monitors spacecraft 100 subsystems for power and temperature. The integrated circuit 158 has the ability to quickly detect faults and respond appropriately while the central computer 156 is doing computationally heavy tasks such as autonomous driving.

The IAU 122 can be utilized in rapidly supported, documented development processes that quickly integrate into new spacecraft applications. In this exemplary embodiment, the IAU 122 is a durable, radiation hardened IAU that can be available for extended missions in harsh environments. The modular design of the central computer 156 provides the ability for utilization in systems that include multiple central computers working in parallel in complicated missions. The integrated circuit 158 can be configurable with an extremely high pin-count and built-in field-programmable gate array (FPGA) that allows for interfacing with nearly any other system.

In one exemplary embodiment, the IAU 122 includes a Quad-core ARM Cortex 1.5 GHZ main processor and a processor Dual-core Arm Cortex 600 MHZ real-time processor. The FPGA includes 256K logic cells. The IAU 122 includes memory that has 4 Gb 64-bit DDR4 RAM 32 Gb in Application Storage Space, a 256 Mb Boot-loader & File system, and a Graphics Processing Mali that has 400 MP2 and 667 MHZ.

The IAU 122 can utilize High-speed Interfaces that include 16×16.3 Gb/s Transceivers, 4×Gigabit Ethernet and a 2×USB3.0 connection. The I/O system is 252×I/O. The IAU 122 has a sleep power specification of 0.5 W and an operational power specification of 10 W. The mass is 90 g. The operating temperature range is −40 C. to 85 C.

As shown in FIG. 2, the electronic board 152 includes a pair of motor controllers 160 and a wi-fi interface 162. The motor controllers 160 can be motor drivers that are accessible for a variety of applications. For example, the motor controllers 160 can drive the motors 138 shown in FIG. 1 to drive the spacecraft 100 to move on a planetary or lunar surface, to deploy the spacecraft 100 from storage on a lander (not shown) on another vehicle (not shown), and/or to actuate a manipulator (not shown) or small subsystem (not shown).

The motor controllers 160 can be accessible over a common communication bus. The integrated circuit 158 can regulate and monitor power usage by the motors 138 to ensure safe operation and fault detection.

The wi-fi interface 162 wi-fi is a common interface utilized across systems to allow for case of prototyping and testing with terrestrial hardware. The IAU 122 integrates directly with wi-fi radio hardware with wi-fi radio hardware without need for a translation layer allowing for seamless hardware integration without any throughput reductions.

The electronic board 154 includes a power control system 164, an inertial measurement unit (IMU) 166, a temperature control system 168, an Ethernet switch 170, and a motor multiplexer 172. The power control system 164 includes a power regulator 174 and a cell balancer 176.

The power control system 164 can provide proper power regulation and distribution to enhance risk management and radiation tolerance of the spacecraft 100. Such enhancements are desirable due to the large amount of subsystems interior to and external to the IAU 122.

The power control system 164 utilizes common power buses of 48 VDC to high power the motors 138. Power buses of 28 VDC are utilized to interact with the lander 122 and/or the payloads 144. The power control system 164 utilizes power buses of 12VDC for cameras 134, heaters 126, heaters 136, heaters 142, and/or heaters 150. The power control system 164 utilizes power buses ranging from 5 VDC and 3.3 VDC to power small logic, support circuitry and the central computer 156 and/or the integrated circuit 158. All the power buses are constantly being monitored by the integrated circuit 158 to ensure that the power busses remain within the specifications needed for the subsystem on the bus.

Further, the power buses can be turned on/off by the integrated circuit 158, so that a subsystem can be power cycled to reset any faults that may have occurred due to radiation or other unexpected events.

Even though some subsystems use the same voltage, all subsystems are isolated to their own power domain such that an error or failure on one power rail can be isolated and does not cascade to others.

The IMU 166 is an onboard IMU. The IMU 166 provides for proper pose estimation during a descent from an external lander (not shown), as well as hazard avoidance on rough terrain during navigation.

The temperature control system 168 utilizes a separate heater controller 178 and temperature monitor 180, so that the functions are in separate domains in a similar manner in which the power control system 164 utilizes a separate power regulator 174 and cell balancer 176.

The IAU 122 can be enclosed within a multi-layer insulation (MLI) 182 enclosure (not shown) to maintain a predetermined internal temperature. The temperature control system 168 can control and regulate temperature of various subsystems within the spacecraft 100 that are not within the MLI enclosure. Such subsystems can have stringent temperature guidelines to function properly.

The IAU 122 can utilize the integrated circuit 158 to process temperature sensor inputs and heater outputs relating to the various subsystems within the spacecraft 100. The integrated circuit 158 can drive the heaters 126, the heaters 136, the heaters 142, and/or the heaters 150, as well as change duty cycles, to maintain recommended temperature ranges within the spacecraft 100.

The Ethernet switch 170 can utilize integrated Ethernet switch circuitry that is incorporated into the IAU 122 to expand the breadth and quantity of sensors available to interface with the central computer 156. In one exemplary embodiment, the spacecraft 100 can utilize up to eight cameras that have been integrated with the spacecraft 100 only utilizing two of the available four GigE channels.

Now referring to FIGS. 1-2, the battery pack 148 is a common interface for any mobile application. The IAU 122 utilizes the cell balancer 176, which includes autonomous cell balancing circuitry that is highly configurable based on the cell chemistry and size of the batteries within the battery pack 148. Through the utilization of the cell balancer 176, the IAU 122 can monitor and safely manage the battery pack 148 for the spacecraft 100.

The battery pack 148 is highly integrated with the IAU 122, which is advantageous given the size, mass and thermal constraints of the spacecraft body 110. When the battery pack 148 is in proximity to the IAU 122, the need for separate enclosures and bracketry is reduced. Further, the potential for increased energy to control an external pack, thermally, is enhanced, as well.

The solar panel 132 with the solar array assembly 112 keeps the battery pack 148 charged. The use of the solar panel 132 in this manner is very mission and system dependent, but the IAU 122 maintains flexibility to provide such options. Alternatively, multiple charging methods are contemplated, including wireless charging systems. Charging systems that are based on solar panels and wireless charging are scalable and flexible based upon mission type.

The cameras 134 are needed for a variety of tasks on a mobile platform, including autonomous navigation, teleoperation, hazard avoidance, and system monitoring. The IAU 122 is equipped with a standard interface for supporting the cameras 134 with an Ethernet interface (i.e., the Ethernet switch 170). The IAU 122 utilizes the temperature control system 168 to ensure that the cameras 134 stay within a safe thermal operational window.

The spacecraft 100 includes an RS422 interface between lander interface 120 and the IAU 122, which is common across other IAUs (not shown). The interface provides the IAU 122 with a direct link to send telemetry during transit and on the surface to a lander (not shown) through the lander interface 120.

Further, the lander interface 120 can include a power rail, which allows the battery pack 148 to remain fully charged and the IAU 122 to remain active during flight.

The pair of HDRMs 124 can be used to release the spacecraft 100 from a transit storage location. Alternatively, the pair of HDRMs 124 can be used onboard the spacecraft 100 to secure subsystems, such as manipulator arms, solar panels, and/or covers for instruments.

The IAU 122 includes a standard HDRM interface to facilitate the receipt of power from the power source 118. The IAU 122 can receive feedback about the state of the HDRMs 124 to determine whether it is necessary to attempt to have one or both of the HDRMs 124 attempt to perform a function, again.

The IAU 122 can interface with the payload assemblies 126, as well as other systems that are impractical to integrate with the IAU 122 directly. Standard connector layouts can be implemented, so that the IAU 122 can provide power to the payload assemblies 126, a communication interface to the payload assemblies 126, power for heaters 126, heaters 136, heaters 142, and/or heaters 150, and/or feedback for temperature sensors.

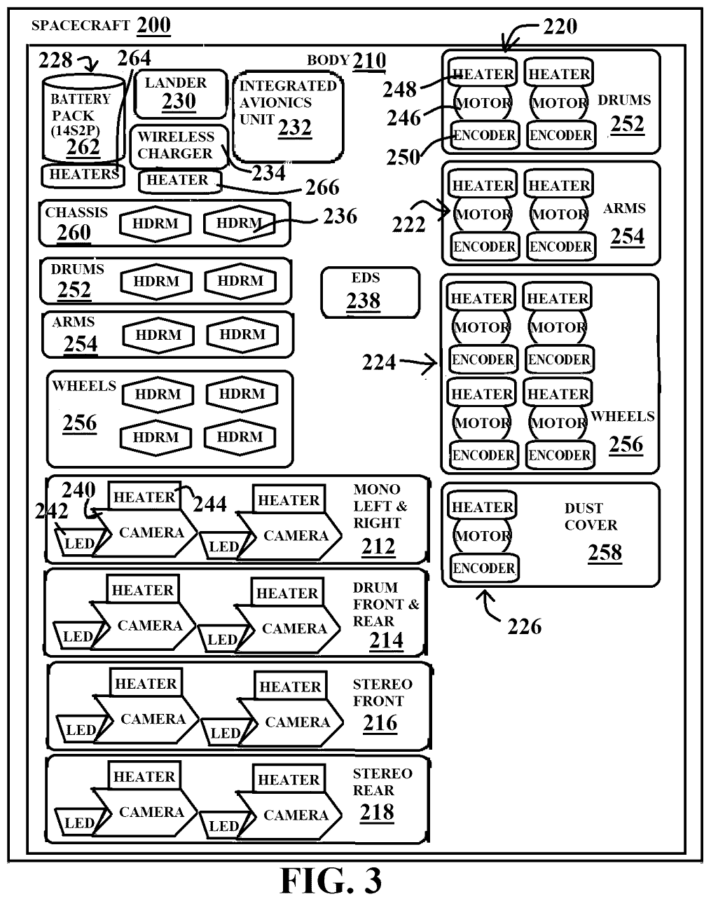

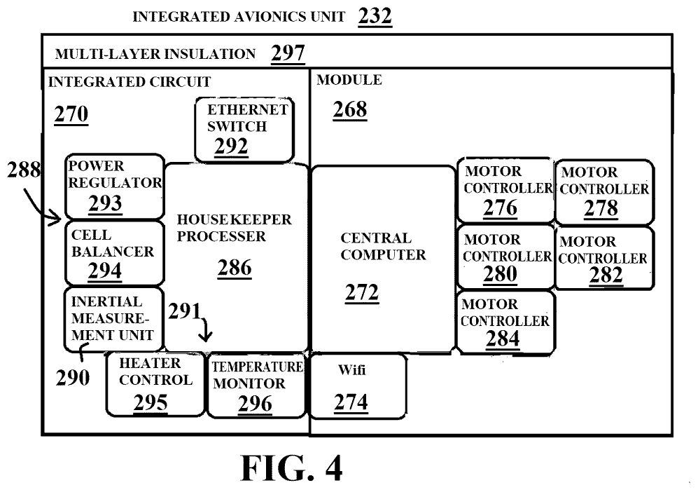

Referring now to FIGS. 3-4 with continuing reference to the foregoing figures, another embodiment of a spacecraft, generally designated as numeral 200, is shown. In this exemplary embodiment, the spacecraft 200 is a lunar exploration vehicle, namely an excavation rover.

Like the embodiment shown in FIGS. 1-2, the spacecraft 200 includes a body 210. The body 210 includes a plurality of sensor assemblies 212-218, a plurality of motor assemblies 220-226, a power source 228, a lander interface 230, and an IAU 232. Unlike the embodiment shown in FIGS. 1-2, the spacecraft 200 includes a wireless charger 234, a plurality of HDRMs 236, and an emergency detection system (EDS) 238.

Each of the sensor assemblies 212-218 includes a pair of cameras 240. Each camera 240 includes a light emitting diode (LED) 242 and a heater 242. The sensor assembly 212 includes a mono-camera positioned on the left side of the body 210 and a mono-camera positioned on the right side of the body 210. The sensor assembly 214 includes a camera positioned on the front of the body 210 and a drum camera positioned on the rear of the body 210. The sensor assembly 216 includes a pair of stereo cameras positioned on the front of the body 210. The sensor assembly 218 includes a pair of stereo cameras positioned on the rear of the body 210.

Each of the motor assemblies 220-226 includes one or more motors 246 with each motor 246 having a heater 248 and an encoder 250. The motor assembly 220 is positioned on drums 252. The motor assembly 222 is positioned on arms 254. The motor assembly 224 is positioned on wheels 256. The motor assembly 226 is positioned a dust cover 258.

A pair of HDRMs 236 are mounted on the drums 252, the arms 254, and a chassis 260. Four HDRMs are mounted on the wheels 256.

The power source 228 includes a battery pack 262 and one or more heaters 264. The wireless charger 234 includes a heater 266.

As shown in FIG. 4, the IAU 232 include a module 268 and an integrated circuit 270. Like the embodiment shown in FIG. 2, the module 268 includes a central computer 272 and a Wi-Fi interface 274. Unlike the embodiment shown in FIG. 2, the module 268 includes five motor controllers 276-284

The integrated circuit 270 includes a housekeeper processor 286, which functions in a similar manner as the watchdog processor 158 shown in FIG. 2. The integrated circuit 270 also includes a power control system 288, an IMU 290, a temperature control system 291, and an Ethernet switch 292. The power control system 288 includes a power regulator 293 and a cell balancer 294. The temperature control system 291 includes a heater controller 295 and a temperature monitor 296.

The IAU 232 can be surrounded by multi-layer insulation 297.

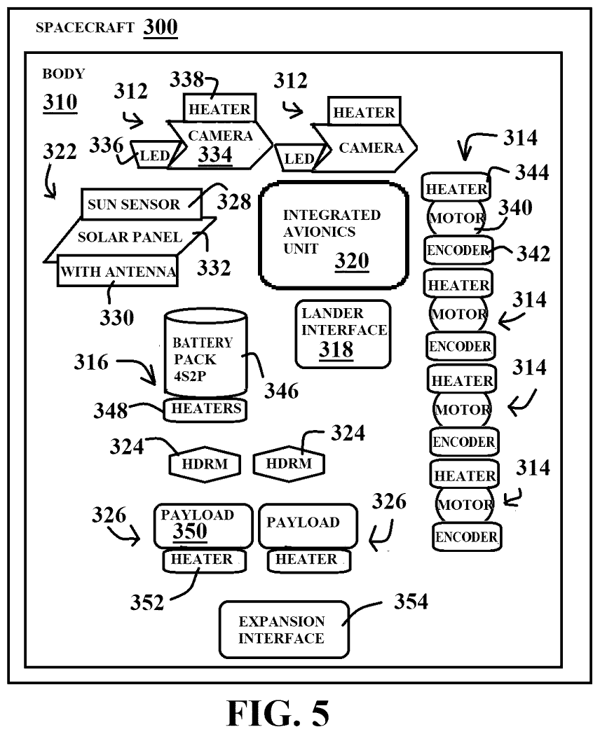

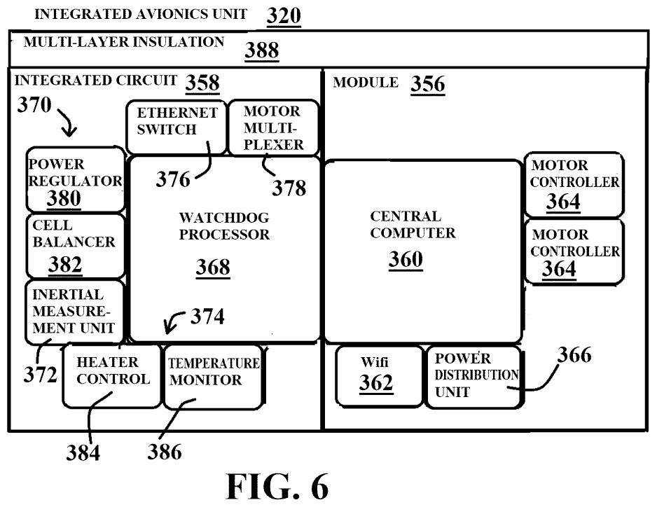

Referring now to FIGS. 5-6 with continuing reference to the foregoing figures, another embodiment of a spacecraft, generally designated as numeral 300, is shown. In this exemplary embodiment, the spacecraft 300 is a lunar rover.

Like the embodiment shown in FIGS. 1-4, the spacecraft 300 includes a body 310. The body 310 includes a plurality of sensor assemblies 312, a plurality of motor assemblies 314, a power source 316, a lander interface 318, and an IAU 320. Like the embodiment shown in FIGS. 1-2, the body 310 includes a solar array assembly 322, a pair of HDRMs 324, and a pair of payload assemblies 326.

The solar array assembly 322 includes a sun sensor 328, an antenna 330, and a solar panel 332. Each sensor assembly 312 includes a camera 334, an LED 336, and a heater 338. Each motor assembly 314 includes a motor 340, an encoder 342, and a heater 344. The power source 316 is a battery pack 346 with a heater 348. Each payload assembly 326 includes a payload 350 and a heater 352.

Unlike the embodiments shown in FIGS. 1-4, the spacecraft 200 includes an expansion interface 354. The expansion interface 354 can provide additional functionality to address additional sensing requirements for localization or mobility, which is desirable because no two missions are identical with respect to payload power and communication needs. The expansion interface 354 provides quick turn, mission-specific functionality that can be added to the spacecraft 300 without driving requirements back to the flight qualified IAU 320 to keep the cost of the mission low.

As shown in FIG. 6, the IAU 320 include a module 356 and an integrated circuit 358. Like the embodiment shown in FIGS. 2 and 4, the module 356 includes a central computer 360 and a Wi-Fi interface 362. Unlike the embodiment shown in FIG. 4, the module 356 includes a pair of motor controllers 364 and a power distribution unit 366.

The integrated circuit 358 includes a watchdog processor 368, like the embodiment shown in FIG. 2. The integrated circuit 358 also includes a power control system 370, an IMU 372, a temperature control system 374, an Ethernet switch 376, and a motor multiplexer 378. The power control system 370 includes a power regulator 380 and a cell balancer 382. The temperature control system 374 includes a heater controller 384 and a temperature monitor 386.

The IAU 320 can be surrounded by multi-layer insulation 386.

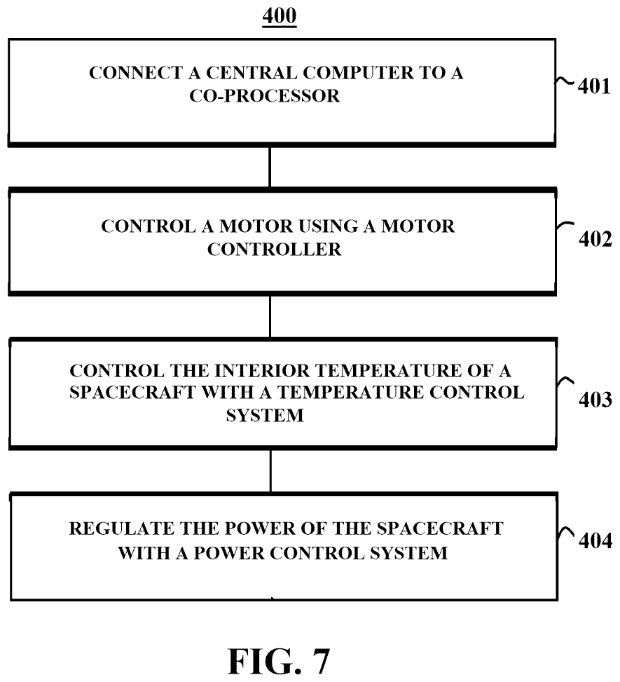

Referring to FIG. 7 with continuing reference to the foregoing figures, an exemplary process, generally designated by the numeral 400, for operating an IAU within a spacecraft. In this exemplary embodiment, the spacecraft can be the spacecraft 100 shown in FIGS. 1-2, the spacecraft 200 shown in FIGS. 3-4 and/or the spacecraft 300 shown in FIGS. 5-6. The IAU can be the IAU 122 shown in FIGS. 1-2, the IAU 232 shown in FIGS. 3-4 and/or the IAU 320 shown in FIGS. 5-6.

At 401, a central computer is connected to co-processor for constant

communication therebetween. In this exemplary embodiment, the central computer can be the central computer 156 shown in FIG. 2, the central computer 272 shown in FIG. 4 and/or the central computer 360 shown in FIG. 6. The co-processor can be the watchdog processor 158 shown in FIG. 2, the housekeeper processor 286 shown in FIG. 4 and/or the watchdog processor 368 shown in FIG. 6.

At 402, a motor controller controls a motor within the spacecraft. In this exemplary embodiment, the motor controller can be one of the motor controllers 160 shown in FIG. 2, one of the motor controllers 276-284 shown in FIG. 4 and/or one of the motor controllers 364 shown in FIG. 6. The motor can be one of the motors 140 shown in FIG. 1, one of the motors 246 shown in FIG. 3 and/or one of the motors 340 shown in FIG. 5.

At 403, a temperature control system controls the interior temperature of the spacecraft using heaters and temperature monitors. In this exemplary embodiment, the temperature control system can be the temperature control system 168 shown in FIG. 2, the temperature control system 291 shown in FIG. 4 and/or the temperature control system 374 shown in FIG. 6.

At 404, a power control system regulates the power of the spacecraft. In this exemplary embodiment, the power control system can be the power control system 164 shown in FIG. 2, the power control system 288 shown in FIG. 4 and/or the power control system 370 shown in FIG. 6.

The IAU uses a hole pattern in the carrier board as a pass through to mount it to the spacecraft chassis on the top surface and secure a dust cover that is affixed to the bottom surface.

### Exemplary Spacecraft

Spacecraft can refer to various types of vehicles that travel into space, through space, or on extraterrestrial bodies. Such vehicles include robotic spacecraft, manned spacecraft, space stations, probes, artificial satellites, capsules, spaceplanes, single-stage-to-orbit vehicle, landers, modular spacecraft, space telescopes, vertical-take-off-vertical landing spacecraft, landing vehicles and/or exploration vehicles.

Exploration vehicles can include a lunar vehicle, an extraterrestrial exploration vehicle, a robotic vehicle, a roving vehicle, and/or a rover. Exemplary exploration vehicles include various embodiments of CUBEROVER® robotic exploration vehicles, such as the 2U CUBEROVER® EM rover, the 2U CUBEROVER® FM rover, the Bottom-Mount CUBEROVER® rover, the 4U CUBEROVER® rovers, the 6U, and/or the CUBEROVER® rovers. CUBEROVER® is a registered trademark of Astrobotic Technology, Inc. of Pittsburgh, Pennsylvania.

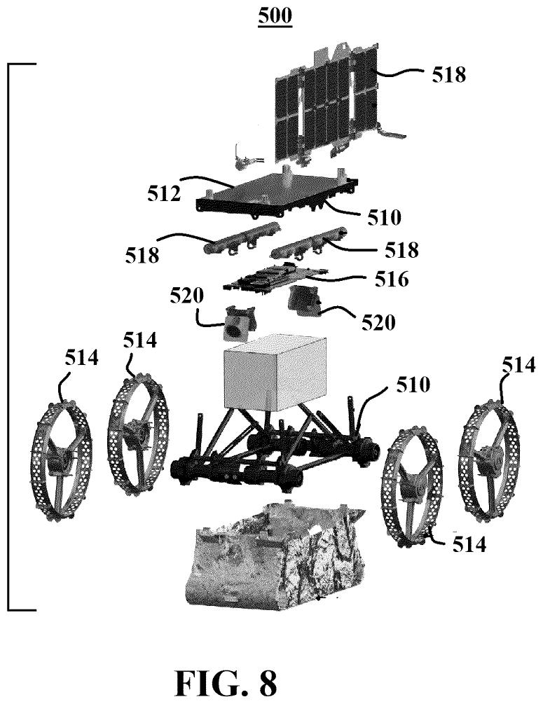

Referring now to FIG. 8 with continuing reference to the forgoing figures, an exemplary spacecraft, generally designated by the numeral 500, is shown. The exemplary spacecraft is a rover. The spacecraft 500 includes a frame 510 for holding a payload (not shown).

The spacecraft 500 includes a thermal control mechanism 512 that regulates and controls thermal interfaces for the payload and for other spacecraft subsystems. A plurality of wheels 514 provides the spacecraft 500 with mobility. The wheels 514 provide optimal performance for navigating the lunar and planetary surfaces.

An avionics and communication assembly 516 performs all command and data handling for the payload and the spacecraft 500. The avionics and communications assembly 516 provides communication services that connect the remote computers to the spacecraft 500.

A power subsystem 518 generates, stores, and distributes power to the payload and to the spacecraft 500. A perception subsystem 520 performs perception and teleoperation functions. The perception subsystem 520 orients and controls spacecraft 500 throughout a mission.

### Exemplary Computing Systems

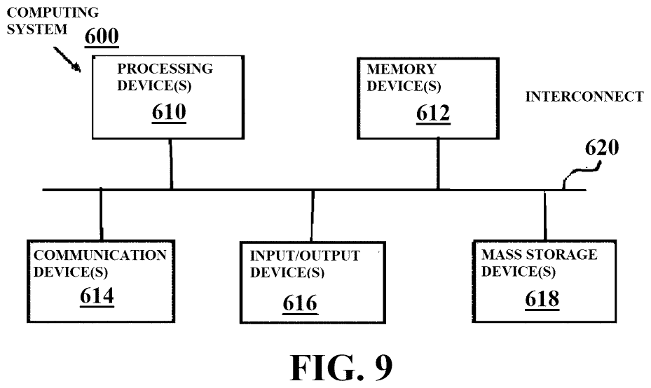

Referring now to FIG. 9 with continuing reference to the forgoing figures, an exemplary computing system, generally designated by the numeral 600, for use by the spacecraft 100 shown in FIGS. 1-2, the spacecraft 200 shown in FIGS. 3-4, the spacecraft 300 shown in FIGS. 5-6 and/or the spacecraft 500 shown in FIG. 8 is shown. The exemplary computing system can be used to practice the method 400 shown in FIG. 7.

The hardware architecture of the computing system 600 that can be used to implement any one or more of the functional components described herein. In some embodiments, one or multiple instances of the computing system 600 can be used to implement the techniques described herein, where multiple such instances can be coupled to each other via one or more networks.

The illustrated computing system 600 includes one or more processing devices 610, one or more memory devices 612, one or more communication devices 614, one or more input/output (I/O) devices 616, and one or more mass storage devices 618, all coupled to each other through an interconnect 620. The interconnect 620 can be or include one or more conductive traces, buses, point-to-point connections, controllers, adapters, and/or other conventional connection devices. Each of the processing devices 610 controls, at least in part, the overall operation of the processing of the computing system 600 and can be or include, for example, one or more general-purpose programmable microprocessors, digital signal processors (DSPs), mobile application processors, microcontrollers, application-specific integrated circuits (ASICs), programmable gate arrays (PGAs), or the like, or a combination of such devices.

Each of the memory devices 612 can be or include one or more physical storage devices, which can be in the form of random access memory (RAM), read-only memory (ROM) (which can be erasable and programmable), flash memory, miniature hard disk drive, or other suitable type of storage device, or a combination of such devices. Each mass storage device 618 can be or include one or more hard drives, digital versatile disks (DVDs), flash memories, or the like. Each memory device 612 and/or mass storage device 618 can store (individually or collectively) data and instructions that configure the processing device(s) 610 to execute operations to implement the techniques described above.

Each communication device 614 can be or include, for example, an Ethernet adapter, cable modem, Wi-Fi adapter, cellular transceiver, baseband processor, Bluetooth or Bluetooth Low Energy (BLE) transceiver, serial communication device, or the like, or a combination thereof. Depending on the specific nature and purpose of the processing devices 610, each I/O device 616 can be or include a device such as a display (which can be a touch screen display), audio speaker, keyboard, mouse or other pointing device, microphone, camera, etc. Note, however, that such I/O devices 616 can be unnecessary if the processing device 610 is embodied solely as a server computer.

In the case of a client device, the communication devices(s) 614 can be or include, for example, a cellular telecommunications transceiver (e.g., 3G, LTE/4G, 5G), Wi-Fi transceiver, baseband processor, Bluetooth or BLE transceiver, or the like, or a combination thereof. In the case of a server, the communication device(s) 614 can be or include, for example, any of the aforementioned types of communication devices, a wired Ethernet adapter, cable modem, DSL modem, or the like, or a combination of such devices.

A software program or algorithm, when referred to as “implemented in a computer-readable storage medium,” includes computer-readable instructions stored in a memory device (e.g., memory device(s) 612). A processor (e.g., processing device(s) 610) is “configured to execute a software program” when at least one value associated with the software program is stored in a register that is readable by the processor. In some embodiments, routines executed to implement the disclosed techniques can be implemented as part of OS software (e.g., MICROSOFT WINDOWS® and LINUX®) or a specific software application, algorithm component, program, object, module, or sequence of instructions referred to as “computer programs.”

Computer programs typically comprise one or more instructions set at various times in various memory devices of a computing device, which, when read and executed by at least one processor (e.g., processing device(s) 610), will cause a computing device to execute functions involving the disclosed techniques. In some embodiments, a carrier containing the aforementioned computer program product is provided. The carrier is one of an electronic signal, an optical signal, a radio signal, or a non-transitory computer-readable storage medium (e.g., the memory device(s) 612).

### Supported Features and Embodiments

Supported embodiments can provide various attendant and/or technical advantages in terms of integrated avionics units for spacecraft. Supported embodiments include an integrated avionics unit for use in spacecraft comprising: a pair of electronic boards consisting of a first electronic board and a second electronic board connected to one another for constant communication therebetween with the first electronic board having a central computer and the second electronic board having an integrated circuit; a motor controller for controlling at least one motor in the spacecraft with the first electronic board directing the operation thereof; a temperature control system for controlling the interior temperature of the spacecraft with the temperature control system having one heater controller and one temperature monitor with the second electronic board directing the operation thereof; and a power control system for regulating the power of the spacecraft with the power control system having a power regulator and a cell balancer with the second electronic board directing the operation thereof.

Supported embodiments include the foregoing integrated avionics unit, wherein the integrated circuit includes an inertial measurement unit.

Supported embodiments include any of the foregoing integrated avionics units, wherein the power control system is incorporated into the integrated circuit.

Supported embodiments include any of the foregoing integrated avionics units, further comprising: a module with the first electronic circuit board and the motor controller being incorporated into the module.

Supported embodiments include any of the foregoing integrated avionics units, wherein the module includes a wi-fi interface.

Supported embodiments include any of the foregoing integrated avionics units, wherein the motor controller includes a motor multiplexer.

Supported embodiments include any of the foregoing integrated avionics units, wherein the integrated circuit includes the motor multiplexer.

Supported embodiments include any of the foregoing integrated avionics units, wherein the spacecraft includes at least one sensor and the integrated circuit includes an Ethernet switch for coupling the sensor thereto.

Supported embodiments include any of the foregoing integrated avionics units, wherein the cell balancer is incorporated into the integrated circuit.

Supported embodiments include any of the foregoing integrated avionics units, wherein the spacecraft includes a battery pack and the integrated circuit monitors the battery pack.

Supported embodiments include any of the foregoing integrated avionics units, wherein the spacecraft includes at least one camera and the central computer monitors the at least one camera.

Supported embodiments include any of the foregoing integrated avionics units, wherein the spacecraft includes at least one hold down release mechanism and the central computer controls the at least one hold down release mechanism.

Supported embodiments include any of the foregoing integrated avionics units, wherein the integrated circuit includes a processor selected from the group consisting of a watchdog processor and housekeeper processor.

Supported embodiments include a spacecraft comprising: a body having a motor, a sensor and a power source for powering the motor, the sensor, and the power source being mounted thereon; and an integrated avionics unit having a module and an integrated circuit with the module having a central computer and a motor controller for controlling the motor and the integrated circuit having a temperature monitoring system for monitoring the temperature of the spacecraft and a power regulator having a cell balancer for regulating the power of the power source; wherein the module and the integrated circuit are connected to one another for constant communication therebetween; and wherein the central computer communicates with the sensor.

Supported embodiments include the foregoing spacecraft, further comprising: a plurality of heaters for heating at least one of the motor, the sensor, and the power source; wherein the integrated circuit include a heater controller with the heater controller being separate from the temperature monitoring system therein.

Supported embodiments include any of the foregoing spacecraft, wherein the spacecraft body includes a payload.

Supported embodiments include any of the foregoing spacecraft, further comprising: a hold down release mechanism mounted within the body.

Supported embodiments include any of the foregoing spacecraft, wherein the integrated circuit includes a processor selected from the group consisting of a watchdog processor and housekeeper processor.

Supported embodiments include any of the foregoing spacecraft, further comprising: a solar panel assembly for providing power to the power source.

Supported embodiments include any of the foregoing spacecraft, wherein the power source is a battery pack.

Supported embodiments include a system, a method, a device, an apparatus, and/or means for implementing any of the foregoing spacecraft, integrated avionics units, or portions thereof.

Supported embodiments include an improved IAU that can be utilized in rapidly supported, documented development processes that quickly integrate the IAU into new spacecraft applications.

Supported embodiments include durable, radiation hardened IAUs available for extended missions in harsh environments.

Supported embodiment include modular systems that include multiple central computers working in parallel in complicated missions.

Supported embodiments include the use of a single central computer that can serve as a robust computer platform for small satellites and teleoperated robots. Such embodiments are suitable for missions that utilize autonomous navigation and/or large robots that are more complex can benefit from additional processing nodes. With predetermined programmable logic and integrated gigabit transceivers, a high-bandwidth data bus and hardware backplane can support many modules in parallel.

The detailed description provided above in connection with the appended drawings is intended as a description of examples and is not intended to represent the only forms in which the present examples can be constructed or utilized. It is to be understood that the configurations and/or approaches described herein are exemplary in nature, and that the described embodiments, implementations and/or examples are not to be considered in a limiting sense, because numerous variations are possible.

Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

What is claimed is:

1. An integrated avionics unit for use in spacecraft comprising:
a pair of electronic boards consisting of a first electronic board and a second electronic board connected to one another for constant communication therebetween with the first electronic board having a central computer and the second electronic board having an integrated circuit;
a motor controller for controlling at least one motor in the spacecraft with the first electronic board directing the operation thereof;
a temperature control system for controlling the interior temperature of the spacecraft with the temperature control system having one heater controller and one temperature monitor with the second electronic board directing the operation thereof; and
a power control system for regulating the power of the spacecraft with the power control system having a power regulator and a cell balancer with the second electronic board directing the operation thereof.

2. The integrated avionics unit of claim 1, wherein the integrated circuit includes an inertial measurement unit.

3. The integrated avionics unit of claim 1, wherein the power control system is incorporated into the integrated circuit.

4. The integrated avionics unit of claim 1, further comprising:
a module with the first electronic circuit board and the motor controller being incorporated into the module.

5. The integrated avionics unit of claim 4, wherein the module includes a wi-fi interface.

6. The integrated avionics unit of claim 5, wherein the motor controller includes a motor multiplexer.

7. The integrated avionics unit of claim 6, wherein the integrated circuit includes the motor multiplexer.

8. The integrated avionics unit of claim 4, wherein the spacecraft includes at least one sensor and the integrated circuit includes an Ethernet switch for coupling the sensor thereto.

9. The integrated avionics unit of claim 4, wherein the cell balancer is incorporated into the integrated circuit.

10. The integrated avionics unit of claim 1, wherein the spacecraft includes a battery pack and the integrated circuit monitors the battery pack.

11. The integrated avionics unit of claim 1, wherein the spacecraft includes at least one camera and the central computer monitors the at least one camera.

12. The integrated avionics unit of claim 1, wherein the spacecraft includes at least one hold down release mechanism and the central computer controls the at least one hold down release mechanism.

13. The integrated avionics unit of claim 1, wherein the integrated circuit includes a processor selected from the group consisting of a watchdog processor and housekeeper processor.

14. A spacecraft comprising:
a body having a motor, a lander interface, a sensor and a power source for powering the motor and the sensor, and the power source being mounted thereon; and
an integrated avionics unit having a module and an integrated circuit with the module having a central computer and a motor controller for controlling the motor and the integrated circuit having a temperature monitoring system for monitoring the temperature of the spacecraft and a power regulator having a cell balancer for regulating the power of the power source;
wherein the module and the integrated circuit are connected to one another for constant communication therebetween; and
wherein the central computer communicates with the sensor.

15. The spacecraft of claim 14, further comprising:
a plurality of heaters for heating at least one of the motor, the sensor, and the power source;
wherein the integrated circuit include a heater controller with the heater controller being separate from the temperature monitoring system therein.

16. The spacecraft of claim 14, wherein the spacecraft body includes a payload.

17. The spacecraft of claim 14, further comprising:
a hold down release mechanism mounted within the body.

18. The spacecraft of claim 14, wherein the integrated circuit includes a processor selected from the group consisting of a watchdog processor and housekeeper processor.

19. The spacecraft of claim 14, further comprising:
a solar panel assembly for providing power to the power source.

20. The spacecraft of claim 19, wherein the power source is a battery pack.
